(19) United States
(12) Patent Application Publication
(10) Pub. No.: US 2018/0136126 A1
(43) Pub. Date: May 17, 2018

(54) LED-BASED ILLUMINATION APPARATUS FOR CONFIGURATION WITH A SPECTRO-FLUOROMETER SYSTEM

(71) Applicant: PROMEGA CORPORATION, Madison, WI (US)

(72) Inventors: ANDREA CHOW, Los Altos, CA (US); IGOR PALGUYEV, Sunnyvale, CA (US); ERIC HEINZ, San Diego, CA (US); BRUCE JOHNSON, San Jose, CA (US); THOMAS WILLSON, Sunnyvale, CA (US); YARON KIDRON, Sunnyvale, CA (US)

(21) Appl. No.: 15/815,914

(22) Filed: Nov. 17, 2017

Related U.S. Application Data
(60) Provisional application No. 62/423,383, filed on Nov. 17, 2016.

(51) Int. Cl. G01N 21/64; G02B 21/06

(52) U.S. Cl. CPC G01N 21/645; G02B 21/06; G01N 2201/0642; G01N 2021/6417; G01N 2021/6482

(57) ABSTRACT

An illumination apparatus for configuration with spectro-fluorometer system includes at least one light emitting diode (LED), a collimator, and a light guide. The at least one LED may be configured to emit light including a first beam-width angle. The collimator is optically coupled to the at least one LED. The collimator is configured to collimate the light emitted from the at least one LED to form a collimated light beam including a second beam-width angle and a first cross-sectional illumination intensity profile. The second beam-width angle may be less than the first beam-width angle. The light guide may be configured to alter a cross-sectional area of the collimated light beam and output a substantially homogenized light beam including a second cross-sectional illumination intensity profile with greater uniformity than the first cross-sectional illumination intensity profile.

### CROSS REFERENCE TO RELATED APPLICATIONS

The present application claims the benefit of U.S. Prov. Pat. Appl. No. 62/423,383, filed Nov. 17, 2016, the entirety of which is incorporated by reference herein.

### BACKGROUND

Certain inventive techniques relating to an illumination (excitation) apparatus for configuration with spectro-fluorometer systems or illumination and spectrographic detection apparatuses configured with spectro-fluorometer systems are disclosed herein. In particular, an LED-based illumination apparatus usable for various scientific applications including relatively high sensitivity multispectral fluorescence detection, for example, capillary electrophoresis (“CE”), is disclosed herein.

CE provides a relatively high sensitivity detection technology that finds application in various fields including, for example, fundamental research, analytical chemistry, separation science, biochemical assay monitoring, forensic science, and drug discovery. For example, fluorescence-based, multi-capillary gel electrophoresis instruments enabled the completion of the human genome project and ushered medical research into an era of personalized medicine and the identification of individuals from DNA provided from a variety of sample types.

### SUMMARY

According to certain inventive techniques, an illumination apparatus for configuration with a spectro-fluorometer system includes at least one light emitting diode (LED), a collimator, and a light guide. The at least one LED may be configured to emit light including a first beam-width angle. The light emitted from the at least one LED may include a wide wavelength range. The collimator may be optically coupled to the at least one LED. The collimator may be configured to collimate the light emitted from the at least one LED to form a collimated light beam including a second beam-width angle and a first cross-sectional illumination intensity profile. The second beam-width angle (for example, less than approximately eight degrees) may be less than the first beam-width angle (for example, greater than approximately 120 degrees). The light guide is optically coupled to the collimator. The collimated light beam may travel between zero mm and 1 mm from the collimator to the light guide. The light guide may be configured to alter a cross-sectional area of the collimated light beam and output a substantially homogenized light beam including a second cross-sectional illumination intensity profile with greater uniformity than the first cross-sectional illumination intensity profile.

A receiving face of the light guide may receive the collimated light beam. An emitting face of the light guide may emit the substantially homogenized light beam. The receiving face may have a greater surface area than the emitting face. The light guide may be tapered (for example, at a substantially uniform angle) between the receiving face and the emitting face.

The spectro-fluorometer system configured with an illumination apparatus(es) may further include a spectrographic detection system including a camera. The system may include an optical filter located between the collimator and the light guide. The optical filter may filter the collimated light beam and outputs a filtered light beam including a narrow wavelength range.

The illumination apparatus may include an LED-mounting component to which the at least one LED is mounted and a heat-sinking component thermally coupled to the LED-mounting component. The apparatus may further include a cooling component (for example, a fan or a thermal electric cooler) configured to stabilize a temperature of the heat-sinking component. The apparatus may include a temperature sensor thermally coupled to the heat-sinking component, wherein the temperature sensor may be part of a control loop with the cooling component to maintain a substantially constant temperature at a location of the temperature sensor.

According to certain inventive techniques, a method for illuminating a sample in a spectro-fluorometer system configured with an illumination apparatus may include: emitting, with at least one light emitting diode (LED), light including a first beam-width angle (for example, greater than approximately 120 degrees); collimating, with a collimator, the light emitted from the at least one LED to form a collimated light beam including a second beam-width angle (for example, less than approximately eight degrees) and a first cross-sectional illumination intensity profile, wherein the second beam-width angle is less than the first beam-width angle; receiving, with a light guide, the collimated light beam; altering, with the light guide, a cross-sectional area of the collimated light beam; and outputting, by the light guide, a light beam including a second cross-sectional illumination intensity profile with greater uniformity than the first cross-sectional illumination intensity profile. A temperature of the at least one LED may be substantially stabilized with a control loop including a cooling component (for example, a fan or a thermal electric cooler) and/or a temperature sensor. A receiving face of the light guide may receive the collimated light beam. An emitting face of the light guide may emit the substantially homogenized light beam. The receiving face may have a greater surface area than the emitting face. The light guide may be tapered (for example, at a substantially uniform angle) between the receiving face and the emitting face.

### BRIEF DESCRIPTION OF SEVERAL VIEWS OF THE DRAWINGS

FIG. 1 illustrates an exploded view of an illumination apparatus, according to certain inventive techniques.

FIG. 2A illustrates an exploded view of a spectro-fluorometer system configured with illumination apparatuses, according to certain inventive techniques.

FIG. 2B illustrates a spectro-fluorometer system configured with an illumination apparatus, according to certain inventive techniques.

FIG. 2C illustrates a spectro-fluorometer system configured with two illumination apparatuses, according to certain inventive techniques.

FIG. 3 illustrates two illumination apparatuses illuminating a capillary array, according to certain inventive techniques.

FIG. 4 illustrates the operation and configuration of a spectro-fluorometer system including a spectrographic detection system and illumination apparatuses, according to certain inventive techniques.

FIG. 5 shows a flowchart for a method of operating an illumination apparatus, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

Certain inventive techniques may implement one or more relatively stable, high-power fluorescence illumination apparatuses (or modules, components, or apparatuses) for configuration with a spectro-fluorometer system (for example, for use in CE systems). Such an illumination apparatus may incorporate relatively bright LEDs (having relatively low cost and high reliability) and may be designed to yield a relatively uniform intensity profile over a relatively large area suitable for multi-capillary array excitation.

In CE systems, fluorescence excitation may be accomplished using lasers. A laser light source may provide a collimated beam characterized by a narrow wavelength and a high photon density, thereby enabling relatively high sensitivity measurements when the area of excitation is relatively small (for example, on the order of tens of micrometers in diameter). However, when the area of excitation is relatively large (for example, on the order of millimeters for multiple capillaries), the laser requirements (for example, power requirements) may become relatively demanding and costly. Although an optical configuration with side-on excitation from capillary to capillary may be used to overcome this limitation on a small excitation area, uniformity in excitation intensity among capillaries may be challenging. Instruments built with side-on excitation optical configuration may result in higher sensitivity in the capillaries near the outside of the array compared to those near the center, especially when the number of capillary increases (for example, 24-capillary arrays). Additionally, even with the recent advances in solid state lasers (which may improve the useful life time duration and reliability), the cost of suitable high power lasers (for example, lasers in the range of 10-1000 mW) is relatively high.

Certain inventive techniques provide a relatively stable, high-power fluorescence illumination apparatus for configuration with spectro-fluorometric systems (for example, for use in CE systems) that may use LEDs (having relatively low cost and high reliability) in lieu of lasers. Certain inventive techniques may yield a relatively uniform intensity profile over a large area suitable for multi-capillary array excitation.

Recent improvements in the mass production of ultra-bright LEDs have accelerated consumer adoption of LED lighting which, in turn, has further reduced the cost of ultra-bright LEDs. In scientific instrumentation, however, the adoption of ultra-bright LEDs to replace a laser as a high-intensity light source has been challenging. For example, although the overall light intensity of an ultra-bright LED is relatively high, the light source is not collimated as with a laser. Furthermore, it is not trivial to efficiently direct a diverging light (for example, an LED with a relatively large beam angle) onto an area of interest with sufficiently high photon density required for many scientific applications. Accordingly, certain inventive techniques harness the intensity of this diverging light source onto a relatively small target area.

In order to excite fluorescence molecules migrating through a multi-capillary array window, certain inventive techniques transform the light emitted from one or more LED sources, having relatively non-uniform illumination intensity profiles and relatively wide angles of divergence (for example, greater than approximately 120 degrees), into relatively uniform illumination intensity profiles suitable for illuminating an array of capillaries in CE systems.

To accomplish this, certain inventive techniques include optical elements in the illumination apparatus that may be configured to reshape the light beams such as, for example, a collimator and/or an optical-grade light guide. As used herein, a “light guide,” includes devices such as a light tube, light pipe, integrator, waveguide, or the like. The collimator may effectively collect the diverging light rays and redirect them to a narrower forward angle (for example, less than approximately 8 degrees). The light guide, for example, placed in close proximity to the collimator output, may reshape a roughly circular beam into an elongated shape characterized by relatively uniform intensity at the light guide's output. The beam outputted by the light guide may also have a relatively large angle of divergence. Thus, the output face of the light guide may be positioned in relative close proximity to the sample target (for example, a capillary array window), for example, within zero to 0.25 mm, to avoid an undesirable drop in intensity. This light guide design for excitation may be compatible with bright-field mode and/or dark-field mode. For fluorescence excitation, the light source wavelength may overlap with the excitation spectra of the dyes of interest. Ultra-bright LEDs may offer a selection of wavelengths covering the visible spectrum. Additionally, optical filter(s) (for example, a bandpass filter) may be interposed between the collimator and the light guide to further narrow the wavelength range of interest.

An analysis of one sample during a CE run may take minutes to tens of minutes to complete. Accordingly, certain inventive techniques provide temporally stable excitation over the entire run. The LED(s) output light intensity may depend on the drive current and the junction temperature in the LED(s). To maintain stability in intensity over time, a relatively constant drive current may be provided, and the junction temperature may be controlled. According to certain inventive techniques, a heat sink may be thermally coupled to the LED board. The heat sink may remove unwanted excess heat generated by the LED(s), thereby keeping the junction temperature from exceeding an undesirable level. Furthermore, the temperature of the heat sink may itself be controlled through a fan (for example, a variable-speed fan) or a thermo-electric cooler (“TEC”) thermally coupled to the heat sink with temperature monitoring feedback to maintain a relatively stable junction temperature.

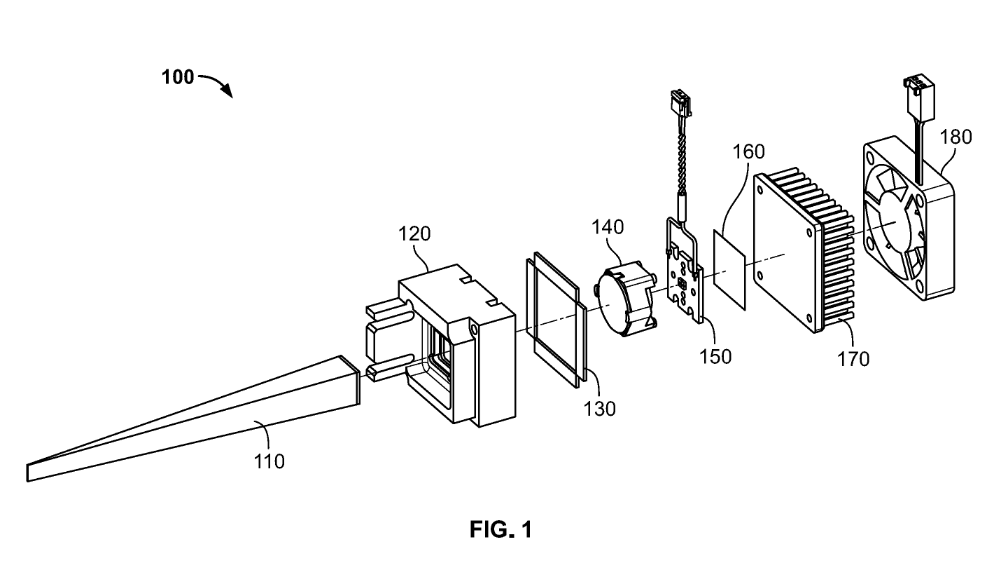

FIG. 1 illustrates an exploded view of an illumination apparatus 100, according to certain inventive techniques. The illumination apparatus 100 may include a light guide 110, a light-guide mount 120, a first thermal coupling component 130, a collimator 140, an LED board 150, a second thermal coupling component 160, a heat sink 170, and/or a fan 180. The illumination apparatus 100 may provide a relatively uniform light output at the narrow end (output) of the light guide 110, which is used to illuminate a sample, such as a capillary array.

One or more LEDs (not shown) may be mounted to the LED board 150. The LED(s) may be, for example, ultra-bright LEDs. The LED(s) may each emit light in a wide wavelength range.

Each LED or the combination of a plurality of LEDs may emit light with a beam-width angle. This beam-width angle may be relatively large, for example, between 10 and 180 degrees. According to certain inventive techniques, this beam-width angle is greater than approximately 120 degrees, for example, 170 degrees. It may also be possible to use other types of light sources other than LEDs (for example, incandescent, halogen, or the like) without departing from the scope of the inventive techniques disclosed herein.

The LED board 150 may include additional circuitry such as, for example, one or more current sources (for example, constant current source(s)). The current source(s) may control the current flowing through the LEDs. Alternatively, the current source(s) may be located remotely, that is, not on the LED board 150. The current source(s) may be controllable (either individually or collectively, if multiple sources are used) to vary the current flowing through the LED(s) to adjust the intensity of the emitted light. Intensity of the light emitted by the LED(s) may be controllable through other techniques such as, for example, switching the power supplied to the LED(s) through a technique such as pulse-width modulation.

The LED board 150 may also include one or more sensors, such as a temperature or an optical power sensor. One or more temperature sensors may be located proximate the LED(s) so the sensed temperature(s) are reflective of the temperature(s) at the junction(s) in the LED(s). These sensed temperature(s) may be used as part of a temperature-adjusting control loop, as will be further described. The temperature sensor(s) may be located on other components besides the LED board 150, for example, on a thermally coupled component, such as the heat sink 170.

The LED board 150 may be electrically coupled to leads that connect to an external circuit board or component. These leads may deliver power to components on the LED board 150. For example, the leads may have one power conductor for delivering power to all components, or may include a plurality of conductors to deliver power to each LED (and corresponding circuitry) individually (or some mix thereof). The leads may also carry control signals to the current source(s) and/or to the LEDs themselves on the LED board 150. The leads may additionally carry signals from the LED board 150 to the external circuit board or component. Such outbound signals may include output(s) from temperature sensor(s) on the LED board 150 (or corresponding signals) or measured voltages or currents.

To assist with heat dissipation and maintaining relatively stable and acceptable temperatures at the LED(s), a heat sink 170 may be included in the illumination apparatus 100. The heat sink 170 may include a relatively planar surface, which may be thermally connected to the LED board 150 (either directly or through an intermediate heat coupling component, such as the second thermal coupling component 160 (which may include a thermal adhesive)). The heat sink 170 may also include a plurality of fins to promote dissipation of heat into the ambient environment. The light-guide mount 120 may also assist with heat dissipation/regulation. For example, to add additional thermal mass, the light-guide mount 120 may be thermally coupled to the heat sink 170, for example, either directly or through an intermediate heat coupling component, such as the first thermal coupling component 130 (which may include a thermal adhesive)).

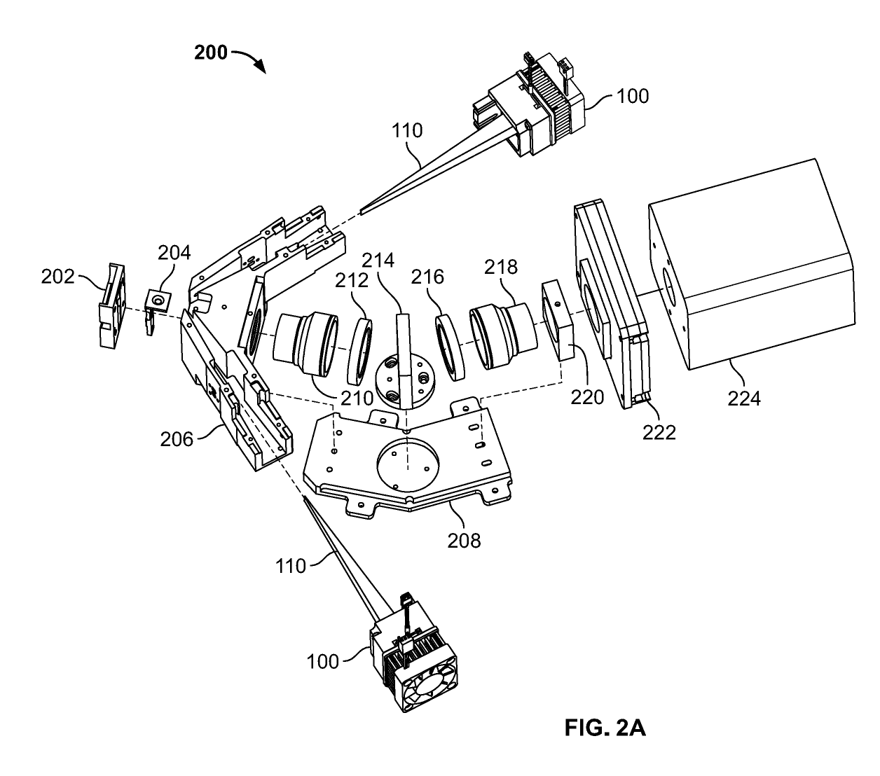

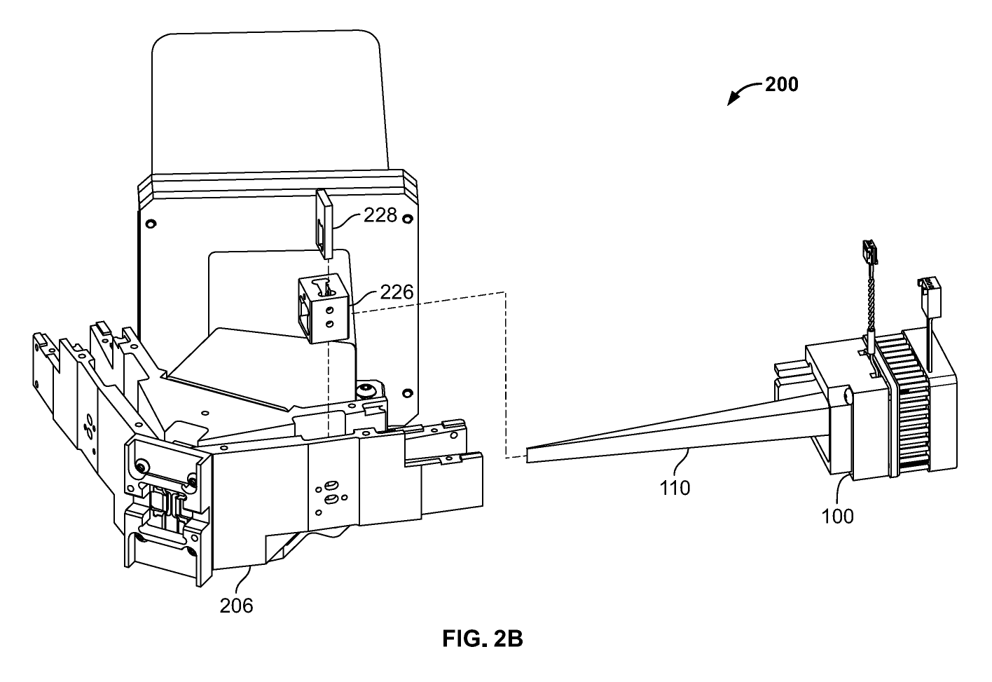

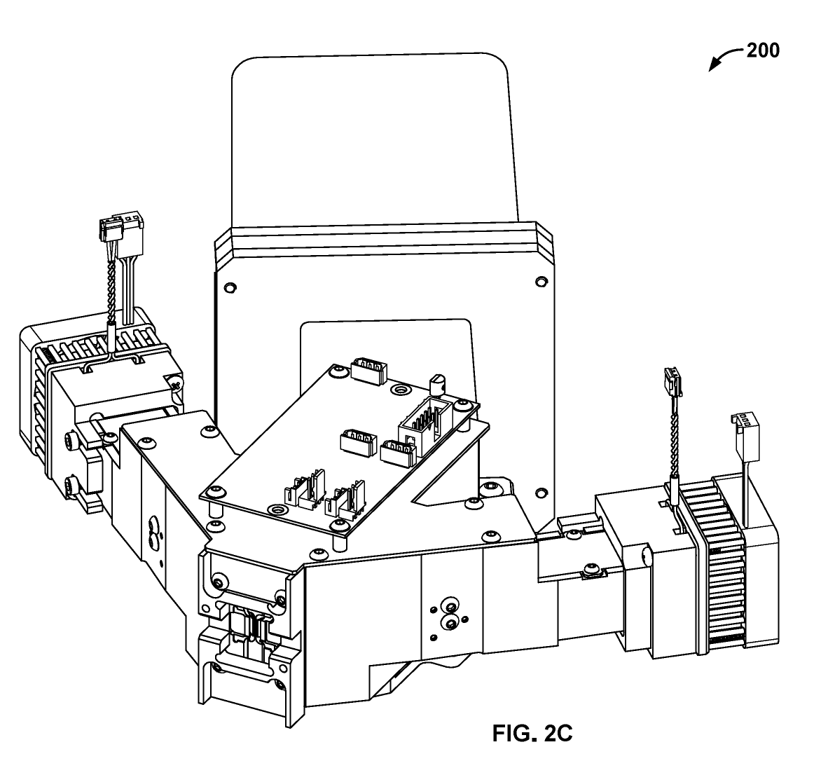

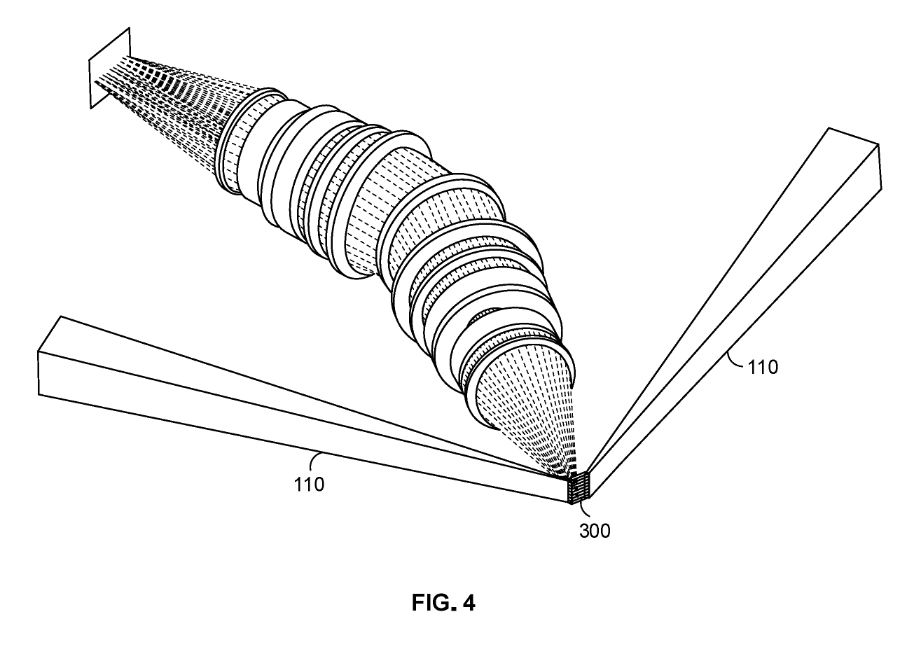

Furthermore, the illumination apparatus 100 may include a cooling component(s), such as the fan 180. The fan 180 may be a variable-speed fan. As another option or addition, a thermoelectric cooler (“TEC”) (not shown) may be thermally coupled to the heat sink 170 (either directly or through thermally conducting material, such as a thermal adhesive). The cooling component(s) may be connected to an external component to provide power and/or signaling as needed. Such signaling may include signal(s) to control the speed of the fan 180 and/or turn the fan 180 ON or OFF. An external processor or other suitable circuitry may receive signal(s) from the temperature sensor(s) and adjust the operation of the cooling component(s) accordingly to maintain a suitably stable and appropriate operating temperature, such that the intensity of the light emitted from the LED(s) may be substantially maintained. Thus, a control loop is formed with the cooling component(s), the processor, and the temperature sensor(s). By maintaining the temperature, the LED(s) may have increased longevity. The processor (either one processor or a plurality of processors acting in coordination) may also be capable of adjusting other operational aspects of the system, such as adjusting the intensity of the at least one LED. The processor may also be able to receive information from the camera in the spectrographic detection system (see FIG. 2C and FIG. 4) to adjust said operational aspects of the system (for example, LED(s) intensity, color, or the like).

The collimator 140 is optically coupled to the LED(s) to receive the emitted light. The collimator 140 collimates the LED-emitted light to form and output a collimated light beam. More generally, the collimated light beam may have a beam-width angle that is less than the beam-width angle of the light emitted directly from the LED(s).

The collimated light beam may optionally pass through one or more optical filter(s) not shown (for example, a bandpass filter) before being received by the light guide 110. The optical filter(s) may filter the collimated light beam and output a filtered light beam including an application specific wavelength range.

The collimated light beam is received by a receiving face of the light guide 110. The light guide 110 may be mounted to the light-guide mounting component 120. The light guide 110 may be formed of or include a material such as poly methyl methacrylate (for example, PMMA or acrylic) or polycarbonate. The collimated light beam may travel between zero mm and 1 mm between the collimator 140 and the receiving face of the light guide 110.

The light guide 110 may further have an emitting face that emits a light beam with improved homogenization from the light received by the light guide 110. The light beam emitted by the light guide 110 may have improved homogenization whereby the light emitted by the light guide 110 includes a cross-sectional illumination intensity profile with greater uniformity than the cross-sectional illumination intensity profile of the received light. As understood herein, a light beam with improved homogenization may be substantially homogenized.

The receiving face may have a greater surface area than the emitting face. In general, the light guide 110 may alter a cross-sectional area of the collimated light beam, for example, reduce the cross-sectional area. The total power of light emitted from the emitting face of the light guide 110 may be less than the total power of light received at the receiving face of the light guide 110—for example, emitted light may have a total power of 10-30% of the received light. The radiance of light emitted from the emitting face of the light guide 110, however, may be greater than the radiance of light received at the receiving face of the light guide 110—for example, the radiance may increase by greater than 200%.

At least some of the outer, lateral surfaces of the light guide 110 may be tapered between the receiving face and the emitting face. The taper may be at a constant angle on one or more faces, or the tapering angle may be irregular (non-constant angle, or increases and decreases between the larger receiving face and the smaller emitting face). The light guide 110 may have a shape as shown with two opposing lateral sides tapered inwardly and two other opposing lateral sides remaining parallel. Other shapes are possible, such as a four-sided truncated pyramid, with the receiving face at the base and the emitting face on the truncated end. As other examples, the light guide 110 may have the form of a frustoconical solid.

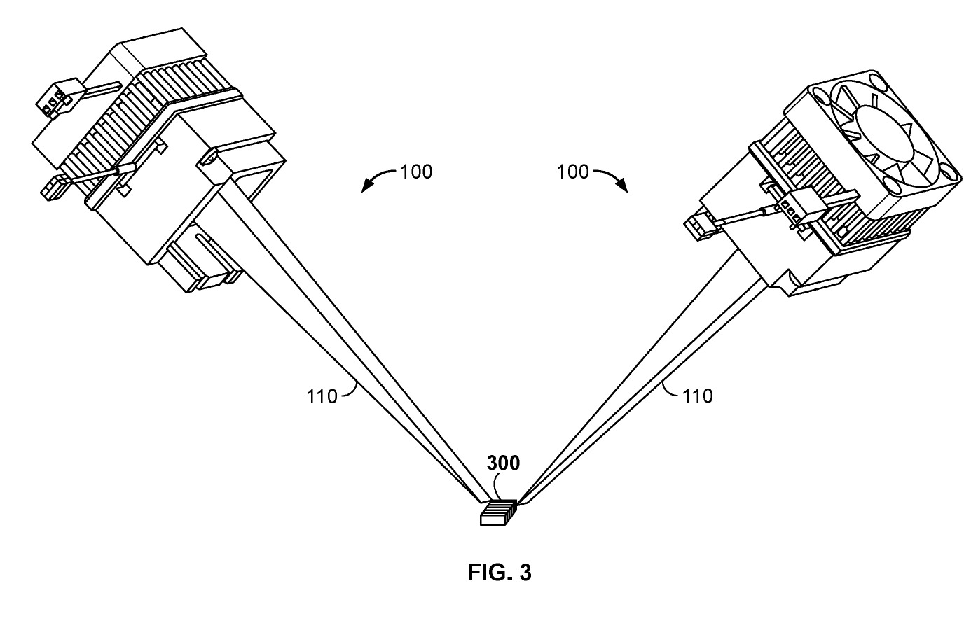

As can be seen in FIG. 3, two illumination components 100 illuminate a capillary array 300, according to certain inventive techniques.

FIG. 2A illustrates an exploded view of a spectro-fluorometer system 200 configured with illumination apparatuses 100, according to certain inventive techniques. FIGS. 2B and 2C illustrate a spectro-fluorometer system 200 configured with illumination apparatuses 100, according to certain inventive techniques. The spectro-fluorometer system 200 includes receiving componentry 206 configured to receive one or more illumination apparatuses 100. The illumination apparatuses 100 may be received in receiving areas or slots in the receiving componentry 206. It may be possible to have only one illumination apparatus 100 in the spectro-fluorometer system 200, or three or more illumination apparatuses 100 according to design objectives.

A given illumination apparatus 100 may be secured and/or aligned in the receiving componentry with components 226 and 228. Component 226 may be semi-permanently secured to the receiving componentry 206 with one or more fasteners (for example, screws).

Light from the illumination apparatus(s) 100 is directed to a capillary array (not shown) that contains material labeled with a fluorescent dye(s). The capillary array may be placed or secured in holder 202. Note, while capillary arrays are primarily disclosed herein, the inventive techniques may be adaptable to other types of samples and are therefore broader than use with only capillary arrays. Furthermore, the capillary arrays can be of varying sizes, for example, containing 8, 16, 24, 48, 96, or more capillaries.

The dye(s) may emit fluorescent light in response to receiving the light emitted from the illumination apparatus(s) 100. Light emitted by fluorescent dyes in the capillary array placed in holder 202 passes through slit 204. The fluorescent light is then collected and collimated by lens 210 (which may be adjusted inside 206 to produce “image at infinity”). Filter 212 may substantially pass the light emitted by florescent dyes and block the light produced by illumination module(s) 100 used to excite the dyes. A volume phase holographic (VPH) grating 214 may receive the light filtered by filter 212. The VPH grating 214 may be arranged in a Littrow configuration, in which the incident light angle and diffracted light angle are equal at a given design wavelength. An additional filter 216 may be located after the VPH grating 214 to further reduce any light from the illumination apparatus(s) 100 that may pass through filter 212 (for example, due to technologically limited light blocking capability). Imaging lens 218 may be mounted in holder 220. The imaging lens 218 may produce an image of the capillary array (as seen by lens 210 through slit 204) onto camera 224 sensor (positioned in assembly 222) in one dimension where each capillary image is shifted in another dimension according to the light spectra produced by fluorescent dyes.

FIG. 4 illustrates an operation and configuration of an exemplary spectro-fluorometer system configured with a spectrographic detection system and illumination apparatuses 100, according to certain inventive techniques. As depicted, light emitted from the light pipes 110 of the illumination apparatuses 100 illuminate a capillary array 300 that includes material labeled with a fluorescent dye(s). The resulting fluorescent light generally follows the paths of the broken lines and impinges on a detector in a digital camera in the spectrographic detection system.

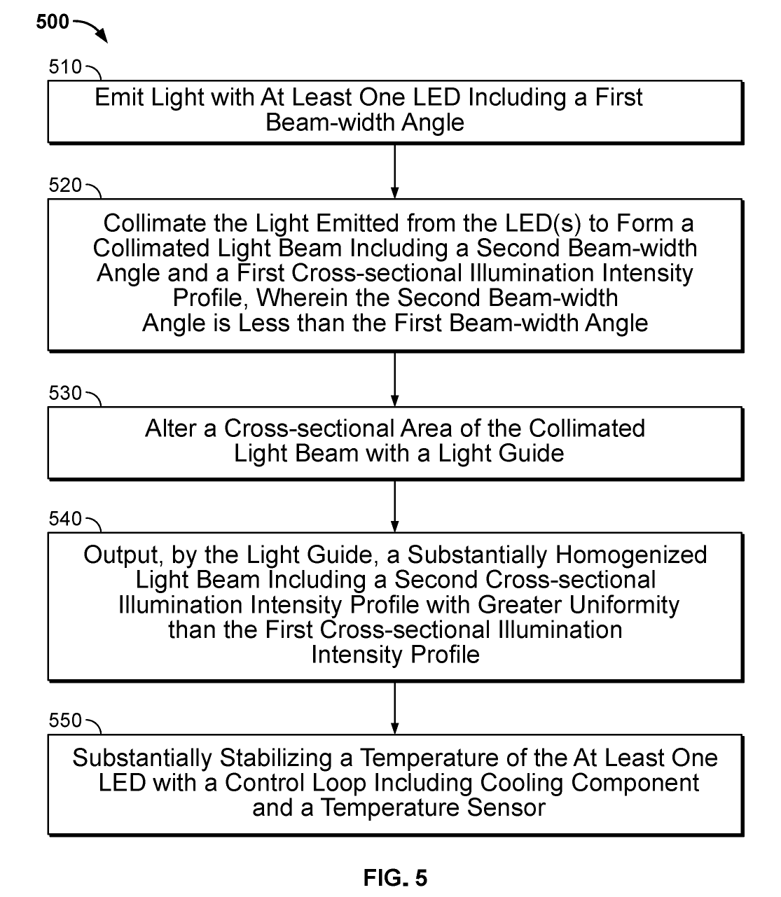

FIG. 5 shows a flowchart 500 for a method of operating an illumination apparatus by illuminating a sample (for example, a capillary array), according to certain inventive techniques. The method may be performed by the spectro-fluorometer system configured with the illumination apparatus(es), described in FIGS. 1-4 and corresponding text.

At step 510, light with a first beam-width angle (for example, greater than 120 degrees) may be emitted from at least one LED. At step 520, the light emitted from the LED(s) is collimated with a collimator to form a collimated light beam including a second beam-width angle (for example, less than eight degrees) and a first cross-sectional illumination intensity profile, wherein the second beam-width angle is less than the first beam-width angle. At step 530, the collimated light beam is received by a light guide, and the cross-sectional area of the collimated light beam is altered. For example, a receiving face of the light guide receives the collimated light beam. An emitting face of the light guide emits the substantially homogenized light beam. The receiving face may have a greater surface area than the emitting face (for example, by virtue of one or more tapers in the light guide). At step 540, the light guide may output a substantially homogenized light beam including a second cross-sectional illumination intensity profile with greater uniformity than the first cross-sectional illumination intensity profile. At step 550, a temperature of the at least one LED may be substantially stabilized with a control loop including a cooling component (for example, a fan and/or a TEC) and a temperature sensor.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. An illumination apparatus for configuration with a spectro-fluorometer system comprising:
at least one light emitting diode (LED) configured to emit light including a first beam-width angle;
a collimator optically coupled to the at least one LED, wherein the collimator is configured to collimate the light emitted from the at least one LED to form a collimated light beam including a second beam-width angle and a first cross-sectional illumination intensity profile, wherein the second beam-width angle is less than the first beam-width angle; and
a light guide optically coupled to the collimator, wherein the light guide is configured to:
alter a cross-sectional area of the collimated light beam; and
output a substantially homogenized light beam including a second cross-sectional illumination intensity profile with greater uniformity than the first cross-sectional illumination intensity profile.

2. The illumination apparatus of claim 1, wherein the first beam-width angle is greater than approximately 120 degrees.

3. The illumination apparatus of claim 1, wherein the second beam-width angle is less than approximately eight degrees.

4. The illumination apparatus of claim 1, wherein the collimated light beam travels between 0 mm and 1 mm from the collimator to the light guide.

5. The illumination apparatus of claim 1, wherein the light emitted from the at least one LED includes a wide wavelength range.

6. The illumination apparatus of claim 1, wherein:
an optical filter is located between the collimator and the light guide; and
the optical filter filters the collimated light beam and outputs a filtered light beam including an application specific wavelength range.

7. The illumination apparatus of claim 1, further comprising:
an LED-mounting component to which the at least one LED is mounted; and
a heat-sinking component thermally coupled to the LED-mounting component.

8. The illumination apparatus of claim 7, further comprising a cooling component configured to stabilize a temperature of the heat-sinking component.

9. The illumination apparatus of claim 8, wherein the cooling component comprises a fan.

10. The illumination apparatus of claim 9, wherein the cooling component comprises a thermal electric cooler.

11. The illumination apparatus of claim 10, further comprising a temperature sensor thermally coupled to the heat-sinking component, wherein the temperature sensor is part of a control loop with the cooling component to maintain a substantially constant temperature at a location of the temperature sensor.

12. The illumination apparatus of claim 1, wherein:
a receiving face of the light guide receives the collimated light beam;
an emitting face of the light guide emits the substantially homogenized light beam; and
the receiving face includes a greater surface area than the emitting face.

13. The illumination apparatus of claim 12, wherein the light guide is tapered between the receiving face and the emitting face.

14. The illumination apparatus of claim 13, wherein the light guide is tapered at a substantially uniform angle.

15. A method for illuminating a sample in a spectro-fluorometer system configured with an illumination apparatus, the method comprising:
emitting, with at least one light emitting diode (LED), light including a first beam-width angle;
collimating, with a collimator, the light emitted from the at least one LED to form a collimated light beam including a second beam-width angle and a first cross-sectional illumination intensity profile, wherein the second beam-width angle is less than the first beam-width angle;
receiving, with a light guide, the collimated light beam;
altering, with the light guide, a cross-sectional area of the collimated light beam; and
outputting, by the light guide, a substantially homogenized light beam including a second cross-sectional illumination intensity profile with greater uniformity than the first cross-sectional illumination intensity profile.

16. The method of claim 15, wherein the first beam-width angle is greater than approximately 120 degrees.

17. The method of claim 15, wherein the second beam-width angle is less than approximately eight degrees.

18. The method of claim 15, further comprising substantially stabilizing a temperature of the at least one LED with a control loop including cooling component and a temperature sensor.

19. The method of claim 18, wherein the cooling component comprises a fan.

20. The method of claim 15, wherein:
a receiving face of the light guide receives the collimated light beam;
an emitting face of the light guide emits the substantially homogenized light beam; and
the receiving face includes a greater surface area than the emitting face.

21. The method of claim 20, wherein the light guide is tapered between the receiving face and the emitting face.

22. The method of claim 21, wherein the light guide is tapered at a substantially uniform angle.

23. A spectro-fluorometer system comprising:
an illumination apparatus including:
at least one light emitting diode (LED) configured to emit light including a first beam-width angle;
a collimator optically coupled to the at least one LED, wherein the collimator is configured to collimate the light emitted from the at least one LED to form a collimated light beam including a second beam-width angle and a first cross-sectional illumination intensity profile, wherein the second beam-width angle is less than the first beam-width angle; and
a light guide optically coupled to the collimator, wherein the light guide is configured to:
alter a cross-sectional area of the collimated light beam; and
output a substantially homogenized light beam including a second cross-sectional illumination intensity profile with greater uniformity than the first cross-sectional illumination intensity profile; and
a spectrographic detection system.
